(19) United States
(12) Patent Application Publication
(10) Pub. No.: US 2005/0251608 A1
(43) Pub. Date: Nov. 10, 2005

(54) Vehicle network with interrupted shared access bus

(76) Inventors: Walton L. Fehr, Mundelein, IL (US); Hugh Johnson, Cedar Park, TX (US); Patrick D. Jordan, Austin, TX (US); Hai Dong, Austin, TX (US)

Correspondence Address: MOTOROLA, INC., 1303 EAST ALGONQUIN ROAD, IL01/3RD, SCHAUMBURG, IL, 60196, US

(21) Appl. No.: 10/842,684

(22) Filed: May 10, 2004

(51) Int. Cl. G06F 13/36

(52) U.S. Cl. 710/309

(57) ABSTRACT

A vehicle network architecture includes an interrupted shared-access bus and a switch fabric incorporated therein at the point of interruption. The switch fabric permits incorporation of a feature or device into the shared access bus architecture without modification or revisions of the shared access bus protocol or legacy devices.

### TECHNICAL FIELD

The present patent relates to vehicles and particularly to communication networks within vehicles.

### BACKGROUND

Vehicle builders have been using serial communication (multiplexing) between controllers to share information and distribute control for some time. Doing so has greatly reduced the amount of vehicle signal wiring needed to implement the comfort, convenience, and safety features desired in modern consumer vehicles.

Control of the devices in the vehicle to implement desired features may be divided into controllers by function (powertrain, braking, steering, etc.), by location (engine compartment, seat, door, etc.) or in combinations thereof. The controller for each of the functions/zones may share information with other controllers using a shared-access serial bus. The bus usually follows an industry standard such as J1850, CAN, LIN, Flexray, MOST and the like, well known to those of skill in the art. Multiple, independent busses may be used. In that case, one of the controllers may act as a gateway for information between the incompatible busses.

An alternative architecture introduces the idea of dividing the vehicle into geographic regions and locating a single controller for all of the features in that region. This architecture may also include the concept of smart peripherals to reduce the number of interconnections in localized areas of the vehicle. The smart peripherals use simple serial communication busses such as LIN busses to relay information from sensors to the zone controller or to accept actuator commands from the zone controller. The zone controllers may be linked by a serial communication bus structure.

Another alternative architecture incorporates a junction block that can be located in various zones of the vehicle. The junction block provides a mechanical and electrical connection point for power, ground and communication for small devices that are used to interface between input and output devices. The junction block also provides over current protection devices for the small connected devices, and multiple power sources distributed at different levels within the system.

Current bus protocols are not easily scalable and are limited in bandwidth. X-by-wire functionality, multimedia infotainment, navigation and other content intensive applications will put more demands on bandwidth and quality of service (QoS) requiring marked improvements in bandwidth, speed, delay, jitter, fault tolerance, message integrity, guaranteed delivery, availability and survivability.

### BRIEF DESCRIPTION OF THE DRAWINGS

This disclosure will describe several embodiments to illustrate its broad teachings. Reference is also made to the attached drawings.

FIG. 1 is a schematic representation of a vehicle incorporating a vehicle network.

FIG. 2 is a schematic block diagram representation of vehicle network including an interrupted shared access bus.

FIG. 3 is a schematic block diagram further illustrating the vehicle network depicted in FIG. 2.

### DETAILED DESCRIPTION

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention. Moreover, structure, features and functions of the herein described embodiments should be considered interchangeable, and every structure, feature or function may be used with any of the embodiments herein described.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. § 112, sixth paragraph.

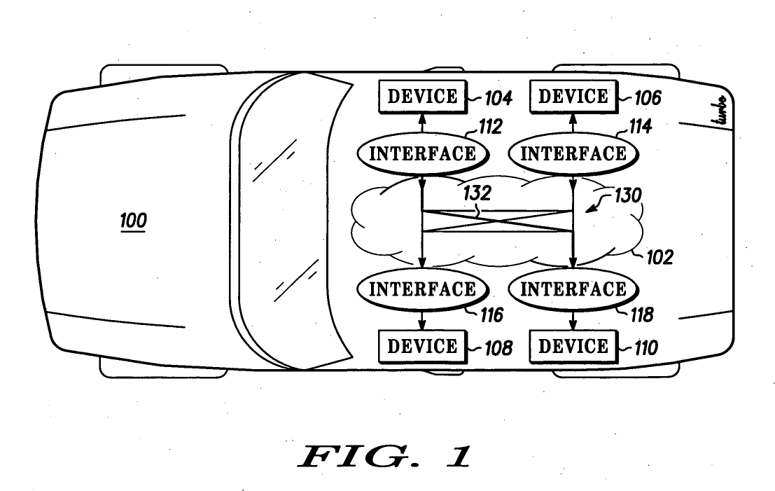

FIG. 1 illustrates a vehicle 100 including a network 102 to which various vehicle devices 104-110 are coupled. The devices may be sensors, actuators, processors and the like used in connection with various vehicle functional systems and sub-systems, such as, but not limited to, control-by-wire applications for throttle, braking, steering and suspension control, power accessories, communications, entertainment, and the like. The vehicle devices 104-110 may be coupled by interfaces 112-118, which may be any suitable interface for coupling the particular device to the network 102, and may be wire, optical, wireless or combinations thereof. It should be understood, however, that the interfaces are not required elements and that the devices 104-110 may be directly coupled to the network or may form portions of the network. The vehicle devices 104-110 may be adapted to provide one or more functions associated with the vehicle 100. These devices may be data producing, such as a sensor, data consuming, such as an actuator, processing or other devices, which both produce and consume data, or routing that transport data within the network. Of course, an actuator, typically a data-consuming device, may also produce data, for example where the actuator produces data indicating it has achieved the instructed state, or a sensor may consume data, for example, where it is provided instructions for the manner of function. Data produced by or provided to a device, and carried by the network 102, is independent of the function of the device itself. That is, the interfaces 112-118 may provide device independent data exchange between the coupled device and the network 102.

The network 102 includes a switch fabric 130 defining a plurality of communication paths 132 between the devices. The communication paths permit multiple simultaneous peer-to-peer or point-to-point, one-to-many, many-to-many, etc. data packet communication between the devices 104-110. During operation of the vehicle 100, data exchanged, for example, between devices 104 and 110 may utilize any available path or paths between the devices. In operation, a single path through the switch fabric 130 may carry all of the data packets representing a communication between the device 104 and the device 110, or several communication paths may carry portions of the data packets. Subsequent communications may use the same paths or other paths as dictated by the then state of the network 102. This flexibility provides reliability and speed advantages over bus architectures that are restricted to single communication paths between devices, and hence are subject to failure with failure of the single path or delays based upon congestion of the path. Moreover, communications between other of the devices 104-110 may occur simultaneously using the communication paths within the switch fabric 130.

The network 102 is a packet data network which may comply with a transmission control protocol/Internet (TCP/IP), asynchronous transfer mode (ATM), Infiniband, RapidIO, or any other packet data protocol now known or later developed. It may also include bus structures that are operated in a packet transit mode, as will be described herein later. As such, the network 102 may use data packets, having fixed or variable length, defined by one or more applicable protocols. For example, if the network 102 uses asynchronous transfer mode (ATM) communication protocol, an ATM standard data cell may be used.

The devices 104-110 need not be discrete devices. Instead, the devices may be systems or subsystems of the vehicle and may include one or more legacy communication media, i.e., legacy bus architectures such as J1850, CAN, LIN, Flexray, MOST or similar bus structures. In such embodiments, the respective interface 112-118 may be configured as a proxy or gateway to permit communication between the active network 102 and the legacy device 104-110.

The network 100, and those described in the afore-mentioned U.S. Provisional Patent Application Ser. No. 60/477,897, have application and as demonstrated may be adapted to operate with legacy architecture, systems and devices. It may become necessary or desirable to retrofit an existing vehicle that is specified with legacy architecture with one or more features that take advantage of the improved capability and QoS of the network structures according to this patent.

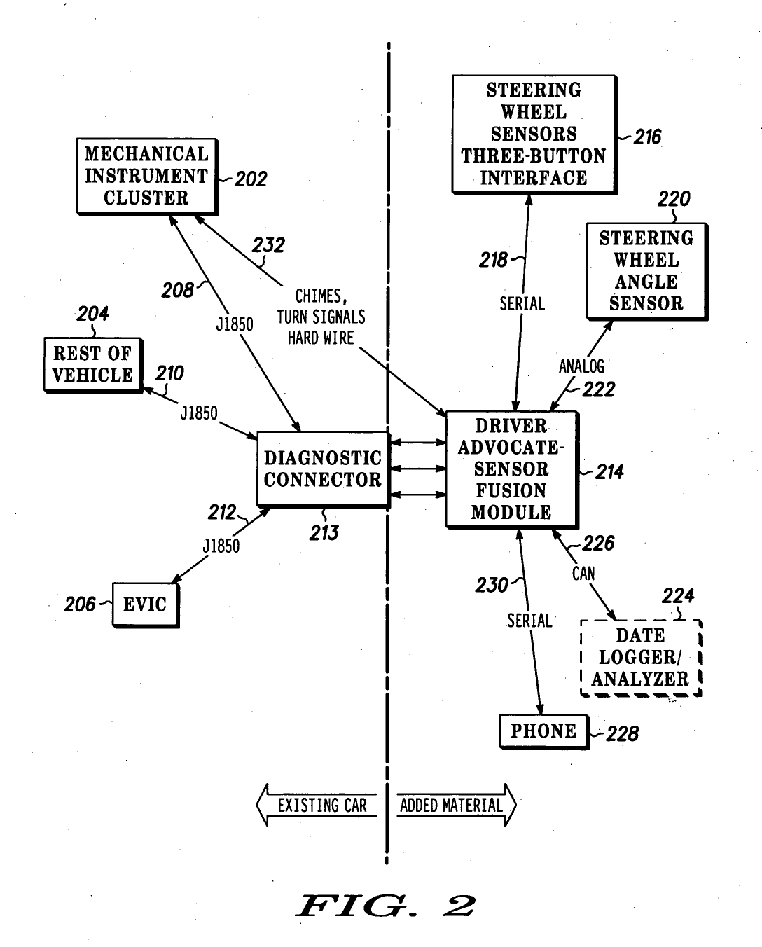

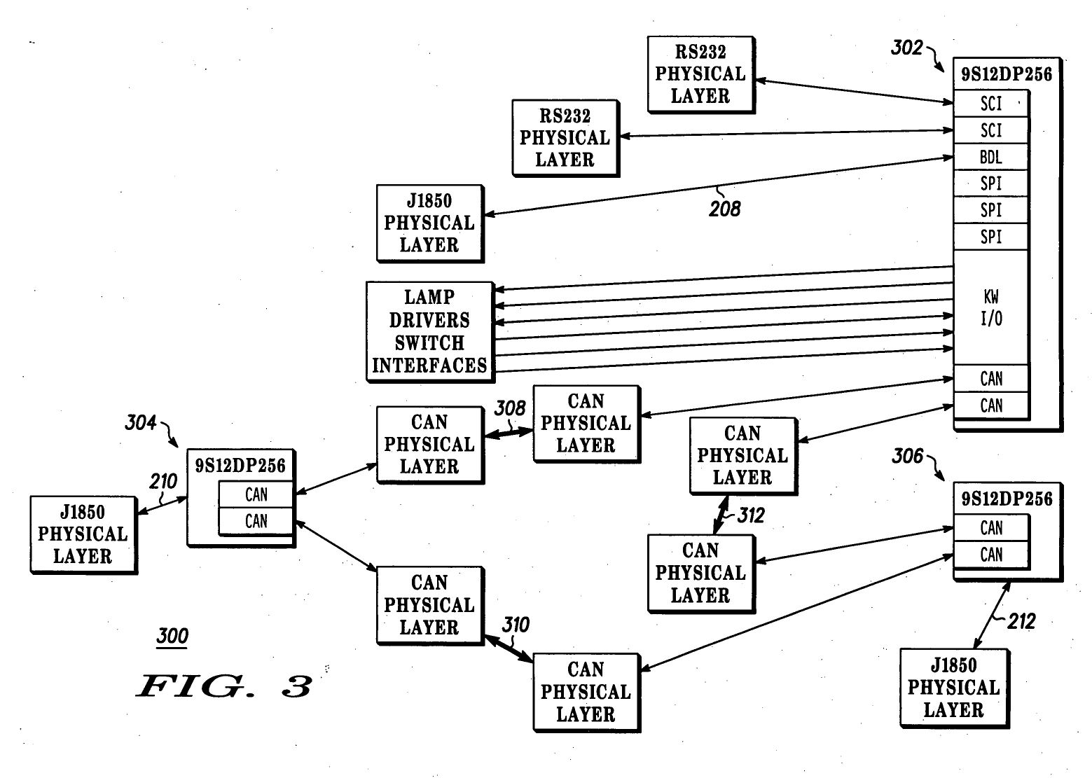

FIGS. 2 and 3 illustrate integration of a feature into a shared-access bus architecture. The feature integrated is an interface designed to manage and control the presentation of information to the user. The interface may be a three button interface such as shown in commonly assigned U.S. patent application Ser. No. 10/458,295, the disclosure of which is hereby expressly incorporated herein by reference, although the application of the structure shown in FIGS. 2 and 3 is not so limited. As mentioned, the vehicle was built with a distributed control system including a number of modules that initiated communications and other modules that operated the presentation devices, e.g., telltales, chimes, message displays, to provide these communications to the user. This information and its presentation to the user would now be managed by the interface. Therefore, it is necessary to be able to obtain the information from the generating modules and to manage and control the presentation devices. However, it may not be possible to access, modify or otherwise alter the existing modules, and advantageously in the described example, such access is not required.

FIG. 2 illustrates the existing vehicle modules 202, 204 and 206 and their corresponding shared-access bus links 208, 210 and 212. The vehicle also includes a diagnostic connector 213, used to physically connect the links 208-212 as will be described. The added interface 200 includes a sensor fusion module 214 to which are coupled: a three-button interface device 216 via a serial link 218, a sensor 220 via an analog link 222, and a data logger/analyzer 224 via a CAN link 226 and a cellular telephone 228 via serial link 230. The sensor fusion module 214 is further hardwire coupled to presentation devices via a hardwire link 232.

To implement the feature using the existing modules 202-206 without modification of the embedded hardware or software, the shared-access bus is segmented to isolate on separate bus segments, segments 208-212 of FIG. 2. A physical connection to these bus segments is provided via the diagnostic connector 213, but certainly other physical arrangements may be made. A switch fabric is architected and inserted into the vehicle to connect the bus segments 202-206, and hence the modules 202-206 to the interface 200.

The switch fabric 300 illustrated in FIG. 3 includes three nodes 302, 304 and 306, which in this exemplary embodiment are 9S12DP256 microcontroller devices which have a J1850 network interface, plural CAN modules, plural serial ports, resident memory and a 16 bit processor unit, although other types of network elements may be used. The bus segments 202-206 are thus coupled via the corresponding J1850 link segments 208-212 to respective ones of the nodes 302-306 (physically via the diagnostic connector 213). The nodes 302-306 are coupled to form the switch fabric via a plurality of CAN links 308-312. The input/output ports of the node 302 couple to the lamp drivers and switch interfaces (not depicted) of the presentation devices and the sensor 218, the serial interfaces of the node 302 couple to the interface 216 and the cellular telephone 222, and the data logger/analyzer 220 is coupled via a remaining CAN module of the node 302 (not depicted) to arrive at that functional arrangement illustrated in FIG. 2. Flow of bus messages from the modules 202-206 are now managed by the switch fabric 300 and the functionality of the installed interface 200. Having been separated from the shared-access bus structure, the existing modules 202-206 no longer receive every message communicated on the shared-access medium, i.e., listen and receive all messages, or send messages according to the transmit protocol. Instead, communication to and from the modules 202-206 is managed by the switch fabric 300.

Prior implementations of add-on features would require redesigning existing modules or getting the cooperation of the module supplier to do the implementation. As described herein, there is now the ability to implement a feature on a trial basis or to create standalone installable products that can be retrofitted into existing vehicle architecture without modification of the existing modules. The switch fabric 300 for this exemplary embodiment was structured from relatively sophisticated microcontroller devices. It will be appreciated that the switch fabric 300 may be formed from devices having less or more capability depending on the application. For example, the switch fabric may incorporate a single intelligent node, e.g., node 302 with the remaining nodes, e.g., nodes 304 and 306 being relatively simple flow control devices. Also, while the embodiment was described as an interface, it should be understood virtually any feature or function may be implemented into an existing architecture using the technique described herein of separating existing modules from a shared-access bus structure and incorporating a switch fabric to manage the control of information from these modules.

Other modifications and alternative embodiments of the invention will be apparent to those skilled in the art in view of the foregoing description. This description is to be construed as illustrative only, and is for the purpose of teaching those skilled in the art the best mode of carrying out the invention. The details of the structure and method may be varied substantially without departing from the spirit of the invention, and the exclusive use of all modifications which come within the scope of the appended claims is reserved.

1. A method of incorporating a feature into a shared-access bus architecture comprising the steps of:
isolating a device from the shared-access bus architecture;
coupling the device to a switch fabric;
providing a feature device for enabling the feature;
coupling the feature device to the switch fabric; and
controlling communication of information between the device and the feature device via the switch fabric.

2. The method of claim 1, wherein the step of coupling the device to the switch fabric comprises coupling the device to a network element of the switch fabric.

3. The method of claim 1, comprising the steps of:
isolating a second device from the shared-access bus architecture;
coupling the second device to the switch fabric; and
controlling communication of information between the device and the feature device via the switch fabric.

4. The method of claim 1, wherein the step of isolating the device from the shared-access bus architecture comprises isolating the device on a shared-access bus segment.

5. The method of claim 3, wherein the step of coupling the device to the switch fabric comprises coupling the shared-access bus segment to a network element of the switch fabric.

6. A vehicle comprising:
a switch fabric;
a device coupled to a first network element of the switch fabric via an isolated shared-access bus segment;
a feature device coupled to a second network element of the switch fabric;
wherein the device and feature device are operably coupled for communication via the switch fabric.

7. The vehicle of claim 6, the first network element being separate and distinct from the second network element.

8. The vehicle of claim 6, comprising a second device coupled via a second isolated shared access bus segment to the switch fabric at a third network element, wherein the second device and the feature device are operably coupled for communication via the switch fabric.

9. The vehicle of claim 6, wherein the switch fabric comprises a plurality of network elements including the first, second and third network elements communicatively interconnected.

10. The vehicle of claim 6, wherein the isolated shared-access bus segment comprises one of a CAN, LIN, MOST, Flexray and J1850 bus segment.

11. A vehicle comprising:
a switch fabric disposed within the vehicle, the switch fabric including a plurality of communicatively coupled network elements; and
a plurality of devices coupled to the switch fabric via isolated shared-access bus segments, wherein communication of information to and from the plurality of devices is controlled by the switch fabric.

12. The vehicle of claim 11, wherein the isolated shared-access bus segment comprises one of a CAN, LIN, MOST, Flexray and J1850 bus segment.

13. A kit for installing a feature on a vehicle comprising:
a switch fabric, the switch fabric including a plurality of communicatively coupled network elements;
a network element of the plurality of communicative coupled network elements being adapted to couple to a device within the vehicle via a isolated shared-access bus segment; and
a feature device coupled to the switch fabric for implementing the feature.

14. The kit of claim 13, further comprising installation instructions.

15. A vehicle including a shared-access bus architecture comprising:
means for isolating a device from the shared-access bus architecture;
means for coupling the device to a switch fabric;
a feature device:
means for coupling the feature device to the switch fabric; and
means for controlling communication of information between the device and the feature device via the switch fabric.

16. The vehicle of claim 15, wherein the means for coupling the device to the switch fabric comprises a network element of the switch fabric.

17. The vehicle of claim 15, comprising:
means for isolating a second device from the shared-access bus architecture;
means for coupling the second device to the switch fabric; and
means for controlling communication of information between the device and the feature device via the switch fabric.

18. The vehicle of claim 15, wherein the means for isolating the device from the shared-access bus architecture comprises a shared-access bus segment.

19. The vehicle of claim 18, wherein the means for coupling the device to the switch fabric comprises means for coupling the shared-access bus segment to a network element of the switch fabric.
